(19) United States
(12) Patent Application Publication
(10) Pub. No.: US 2012/0204668 A1
(43) Pub. Date: Aug. 16, 2012

(54) DOUBLE BUMP SHIFT SELECTOR FOR A VEHICLE

(75) Inventors: Donald J. Zito, Fox River Grove, IL (US); James J. Paris, River Forest, IL (US); Tina Liu, Bloomingdale, IL (US); Ben S. Tebbutt, West Bloomfield, MI (US)

(73) Assignee: CONTINENTAL AUTOMOTIVE SYSTEMS, INC., Deer Park, IL (US)

(21) Appl. No.: 13/025,653

(22) Filed: Feb. 11, 2011

(51) Int. Cl. F16H 59/04

(52) U.S. Cl. 74/473.3

(57) ABSTRACT

A method controls a transmission of a vehicle. The vehicle includes an engine for driving wheels, a transmission coupled between the engine and the wheels. The transmission automatically selects driving gear positions enabling the vehicle to move in a forward or reverse direction. The method provides gear shift structure associated with the transmission. While the transmission is in a presently selected gear position to move the vehicle in the forward or reverse direction, the gear shift structure is permitted to be initially manually engaged and moved to a first position to cause one gear change from the presently selected gear position. While the gear shift structure is in the first position, the gear shift structure is permitted to be manually engaged again to cause a gear change from the one gear change position. The gear change will provide optimum up-shift for performance or, when down-shifting, will provide maximum gear braking.

### FIELD

This invention relates to vehicle transmissions and, more particularly, to a system and method to bump shift a transmission gear shifter to produce maximum allowable shift performance of a vehicle.

### BACKGROUND

Conventional vehicle automatic transmissions provide for the ability to manually “bump shift”. Bumping the gear shift lever forward or backward or side-to-side, or activating a switch located on the gear shift lever, causes a controller to upshift or downshift the transmission into the respective adjacent gear ratio. Bump shifting can also be done using paddle shifters located near the steering wheel. Such bump shifting can aid in braking (e.g., when downshifting) or can cause a gear change to a more optimal gear (e.g., when upshifting). However, the conventional systems allow only one gear change, from the presently selected gear, to be requested.

Thus, there is a need to provide a bump shift arrangement where the operator can bump shift to more than one gear change from the presently selected gear to produce a maximum allowable shift performance in the vehicle.

### SUMMARY OF THE INVENTION

An object of the invention is to fulfill the need referred to above. In accordance with the principles of the present invention, this objective is achieved by a method of controlling a transmission of a vehicle. The vehicle includes an engine for driving wheels and a transmission coupled between the engine and the wheels. The transmission automatically selects driving gear positions enabling the vehicle to move in a forward or reverse direction. The method provides gear shift structure associated with the transmission. While the transmission is in a presently selected gear position to move the vehicle in the forward or reverse direction, the gear shift structure is permitted to be initially manually engaged and moved to a first position to cause one gear change from the presently selected gear position. While the gear shift structure is in the first position, the gear shift structure is permitted to be manually engaged again to cause a gear change from the one gear change position.

In accordance with another aspect of an embodiment, a system is provided for controlling a transmission of a vehicle. The vehicle includes an engine for driving wheels and a transmission coupled between the engine and the wheels. The transmission automatically selects driving gear positions enabling the vehicle to move in a forward or reverse direction. Gear shift structure is associated with the transmission. While the transmission is in a presently selected gear position to move the vehicle in the forward or reverse direction, the gear shift structure is constructed and arranged to be initially manually engaged and moved to a first position to cause one gear change from the presently selected gear position, and while the gear shift structure is in the first position, the gear shift structure being constructed and arranged to be manually engaged again to cause a gear change from the one gear change position.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a block diagram of a system for controlling bump shifting of a transmission of a vehicle, provided in accordance with an embodiment of the invention.

FIG. 2a is a view of a gear shift structure of a first embodiment shown in a standard position.

FIG. 2b is a view of the gear shift structure of FIG. 2a, shown being moved to a forward, first bump shift position.

FIG. 2c is a view of the gear shift structure of FIG. 2b, shown being moved to a forward, second bump shift position.

FIG. 3 is a flow chart for controlling a system employing the gear shift structure of the first embodiment.

FIG. 4a is a view of a gear shift structure of a second embodiment, shown in a standard position.

FIG. 4b is a view of the gear shift structure of FIG. 3a, shown in first bumps shift position, and having a button for moving to a second bump shift position.

FIG. 5 is a flow chart for controlling a system employing the gear shift structure of the second embodiment.

### DETAILED DESCRIPTION OF EXEMPLARY EMBODIMENTS

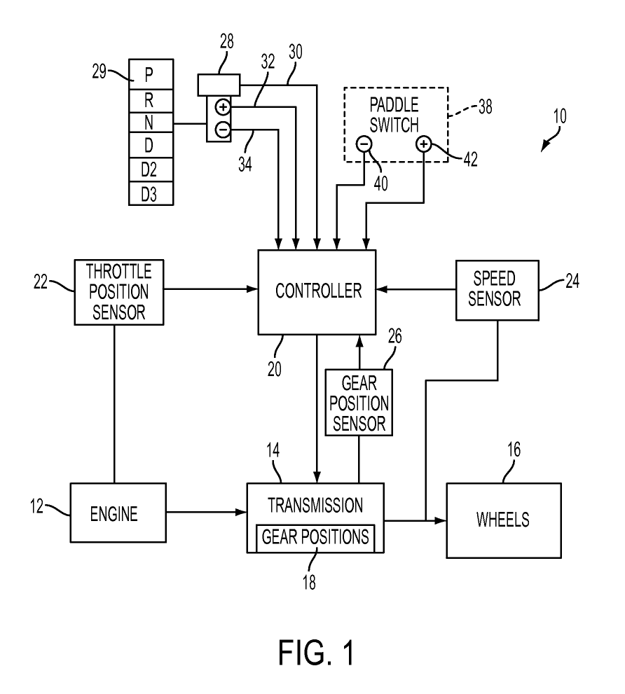

FIG. 1 is a block diagram showing a configuration of a shift control system for a vehicle, generally indicated at 10, according to an embodiment of the present invention. The system 10 includes an engine 12, an automatic transmission 14, and wheels 16. An output from the engine 12 is transmitted through the automatic transmission 14 to the drive wheels 16. The automatic transmission 14 is conventional and typically has five automatically selectable gear positions 18 for forward running, as well as a gear position for reverse running. A powertrain control module (PCM) or controller 20 having a microprocessor is provided and receives input signals from a throttle position sensor 22, a vehicle speed sensor 24, and a gear position sensor 26. The throttle position sensor 26 functions to detect an opening angle of a throttle valve of the engine 12. The vehicle speed sensor 24 functions to detect a vehicle speed, and the gear position sensor 26 functions to detect a present gear position in the automatic transmission 14. The controller 20 basically includes a CPU, ROM, RAM, a clock (soft timer), and an input/output interface. Such a configuration is well known in the case of using a conventional microcomputer, so the description thereof will be omitted herein.

As shown in FIG. 1, gear shift structure, in one embodiment, is a gear shift lever 28 constructed and arranged to place the transmission into the conventional park (P), drive (D, D2, D3), reverse (R) or neutral (N) position as indicated on selector 29. The gear shift lever position signal 30 is input into the controller 20. In addition, the gear shift lever 28 can operate in a manual bump shift mode and when in this mode, an operator induced upshift signal 32 or downshift signal 34 is input into the controller 20 as will be explained more fully below. The control unit 20 outputs a control signal to the transmission 14. The gear shift lever 28 is typically of the conventional shift-by-wire type or can be of the conventional mechanical type with an electrical output signal.

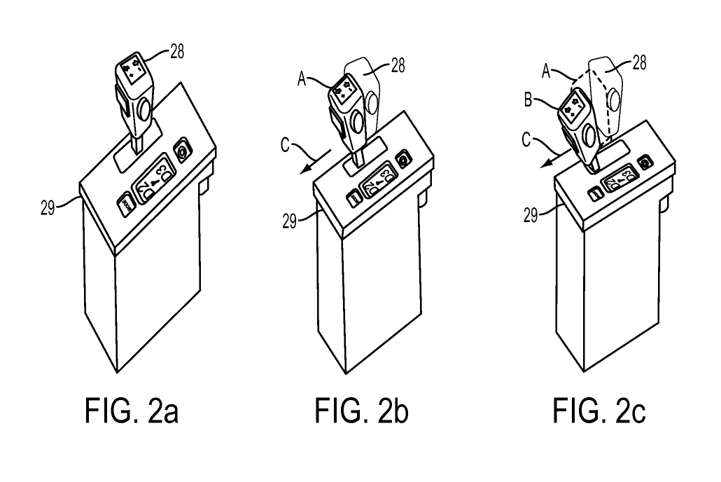

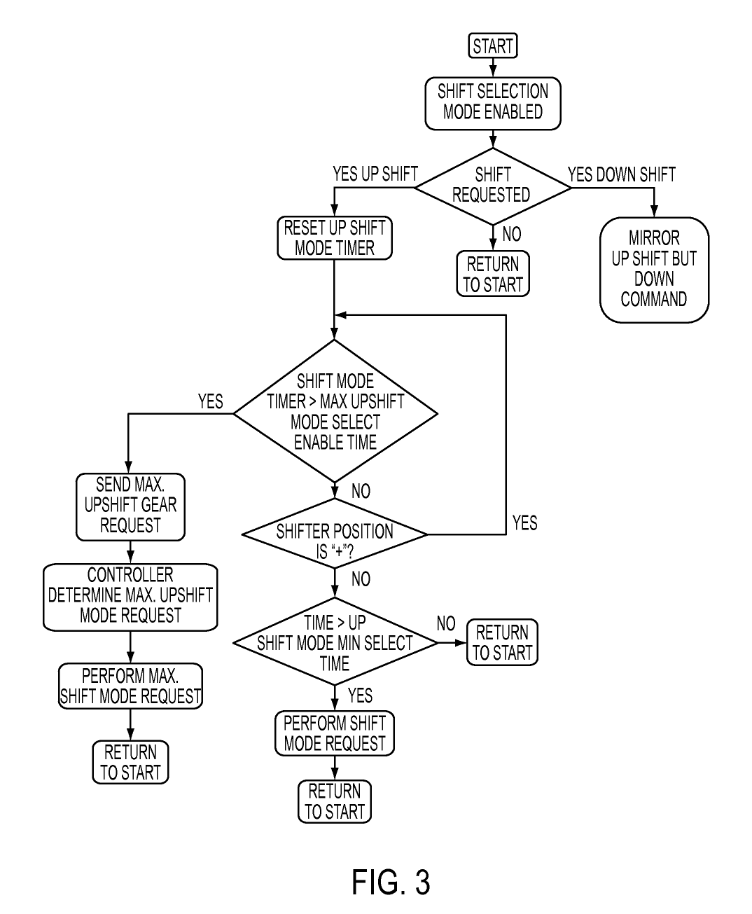

The manual bump shift can be performed only while vehicle transmission 14 is in the drive (D, D2, D3) or reverse (R) positions. For example, FIG. 2a shows the gear shift lever 28 in a standard drive position (e.g., D3). While in this position, the gear shift lever 28 can be initially manually engaged or bumped and moved in a certain direction (e.g., direction C) to a first position (position A in FIG. 2b) to cause one gear change (e.g. + or −1) from the presently selected gear position. If an upshift is requested, signal 32 is sent to the controller 20. If a downshift is requested, signal 34 is sent to the controller 20. In the embodiment, the one gear change position was from D3 to D2 due to an initial forward bump. While the gear shift lever 28 is in the first position and the transmission is in the one gear change position (D2), the gear shift lever is permitted to be manually engaged or bumped again in the direction C to move to a second position B (FIG. 2c) which causes another signal (32 or 34) to be sent to the controller 20 and causes a gear change from the one gear change position (D2) to another gear position (e.g., D). In accordance with the embodiment, the gear change, from the one gear change position (D2), is based on a signal sent to the controller 20 by at least one of the sensors 22, 24 or 26 to optimize vehicle fuel economy based on the state of the vehicle, or to maximize engine braking. Once in the first bump position A, additional force (significantly more than to move to the first bump position) is preferably required to move the gear shift lever 28 to the second bump position B. Such additional force can be provided by dual springs or can be achieved electronically, for example by using proximity sensors or other sensing. Movement of the gear shift lever 28 to the second bump position B results in a maximum allowable transmission shift as determined by the controller 20. FIG. 3 is a flow chart showing the shift logic executed by the controller 20 for the embodiment shown in FIGS. 2a-2b.

The consecutive or double bump shifts explained above occurred in the forward direction C as shown in FIGS. 2b and 2c. However, the dual bump shifts can occur in a direction opposite to the direction C. Furthermore, the bump shift directions be side-to side with respect to the gear shift lever 28 if desired if the gear shift lever is so configured.

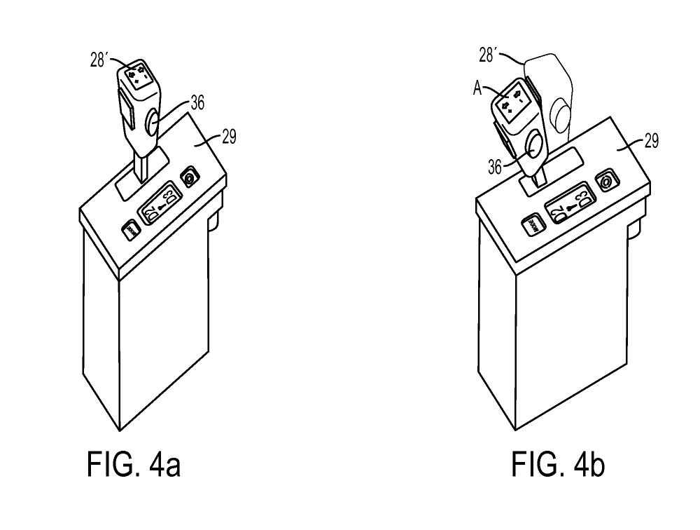

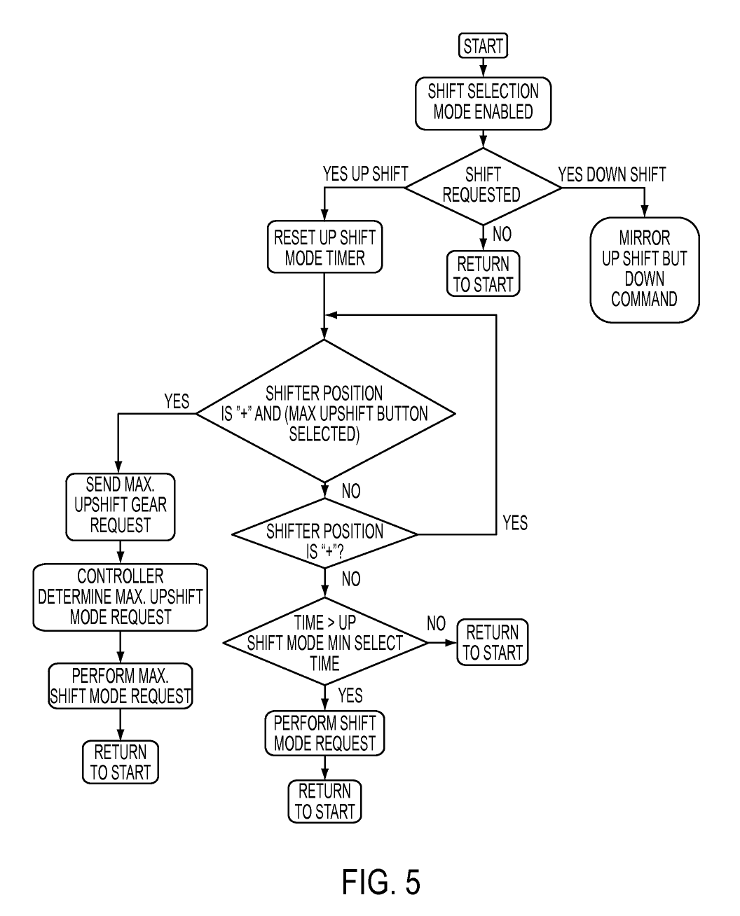

FIGS. 4a and 4b show a second embodiment of the gear shift lever 28′. FIG. 4a shows the gear shift lever 28′ in a standard drive position (e.g., D3). While in this position, the gear shift lever 28′ can be initially bump shifted to the first bump shift position A (FIG. 4b) by bumping the gear shift lever 28′ forwardly (or rearwardly) in the manner discussed above with respect to FIGS. 2b and 2c. Additionally, the gear shift lever 28′ includes a dual or rocker style switch. Once the shift lever 28′ is in the first bump position A, a button or rocker switch 36 can be activated (either “+” or “−”) producing a secondary bump command to be sent to the controller 20, which results in a maximum allowable transmission shift as determined by the controller 20. FIG. 5 is a flow chart showing the shift logic executed by the controller 20 for the embodiment shown in FIG. 4b.

With regard to each embodiment, an additional, second bump shift command requests maximum allowable shift from the transmission 14. A maximum allowable shift up (+) will allow for optimal gear economy while a maximum allowable shift down (−) will provide optimal engine breaking. If the driver selects the bump shift selection mode of operation, conventional configurations allow for selection of one gear change from the presently selected gear to be requested. However, with the embodiments, the driver can select a gear change from the existing gear to the optimal gear to maximize vehicle fuel economy based on vehicle state (throttle position, vehicle speed, current gear, etc . . . ). Additionally the driver can select, through a combination of shifter position and/or button selection, a change of current gear state to maximize the engine braking allowable within the vehicle's engine usable range.

In the embodiments of FIGS. 2 and 4, the gear shift lever 28 not only placed the transmission into the proper gear position (e.g., P, R, N, D, D2, or D3), but was also employed as the structure for controlling the manual bump shifting. However, with reference to FIG. 1, the gear shift structure for controlling the manual upshift or downshift could instead be a paddle switch 38 that preferably includes a pair of paddles 40 and 42. Paddle 40 can be manually engaged a first time, while the transmission is in a gear position such as D3, and moved to a first position to cause one gear change (e.g., D2) from the presently selected gear position, and while the paddle is in the first position with the transmission in the one gear change position (D2), the paddle 40 could be manually engaged again to cause a gear change (e.g. to D) from the one gear change position (D2). The second engagement of the paddle 40 results in a maximum allowable shift as determined by the controller 20. Downshifting can occur in similar manner by engaging paddle 42 two consecutive times.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. A method of controlling a transmission of a vehicle, the vehicle including an engine for driving wheels, a transmission coupled between the engine and the wheels, the transmission automatically selecting driving gear positions enabling the vehicle to move in a forward or reverse direction, the method comprising:
providing gear shift structure associated with the transmission,
while the transmission is in a presently selected gear position to move the vehicle in the forward or reverse direction, permitting the gear shift structure to be initially manually engaged and moved to a first position to cause one gear change from the presently selected gear position, and
while the gear shift structure is in the first position, permitting the gear shift structure to be manually engaged again to cause a gear change from the one gear change position.

2. The method of claim 1, wherein the vehicle also includes a controller associated with the transmission and gear shift structure, and at least one sensor, associated with the controller, for sensing a state of the vehicle, wherein the gear change from the one gear change position is based on a signal sent to the controller by the sensor to 1) to optimize vehicle fuel economy based on the state of the vehicle, or 2) to maximize engine braking.

3. The method of claim 2, wherein the one gear change is one gear position up or one gear position down from the presently selected gear position and wherein the gear change, from the one gear change position, is a change to a maximum gear change position allowed by the controller.

4. The method of claim 1, wherein the gear shift structure is a gear shift lever constructed and arranged to place the transmission in a park, drive, reverse or neutral position.

5. The method of claim 4, wherein the steps of permitting the gear shift structure to be manually engaged includes permitting the gear shift lever to be bumped and moved in a certain direction to the first position to cause the one gear change from the presently selected gear position, and then bumped and moved again in the certain direction to a second position to cause the gear change from the one gear change position.

6. The method of claim 5, wherein the method ensures that a bumping force required to bump the gear shift lever to the second position thereof is greater than a bumping force required to bump the gear shift lever to the first position thereof.

7. The method of claim 4, wherein the gear shift lever includes a switch, and wherein the steps of permitting the gear shift structure to be manually engaged includes permitting the gear shift lever to be bumped and moved to the first position, and once the one gear change is achieved, the step of manually engaging the gear shift structure again includes actuating the switch to cause the gear change from the one gear change position.

8. The method of claim 1, wherein the gear shift structure includes at least one paddle shifter.

9. The method of claim 2, wherein the gear shift structure includes a pair of paddle shifters and the steps of permitting the gear shift structure to be manually engaged includes permitting one of the paddle shifters to be engaged two consecutively times to optimize vehicle fuel economy based on the state of the vehicle, or permitting the other of the paddle shifters to be engaged two consecutive times to maximize engine braking.

10. The method of claim 2, wherein the sensor senses speed of the vehicle, a throttle position of the engine, or a currently selected gear position.

11. A system for controlling a transmission of a vehicle, the vehicle including an engine for driving wheels, a transmission coupled between the engine and the wheels, the transmission automatically selecting driving gear positions enabling the vehicle to move in a forward or reverse direction, the system comprising:
gear shift structure associated with the transmission, while the transmission is in a presently selected gear position to move the vehicle in the forward or reverse direction, the gear shift structure being constructed and arranged to be initially manually engaged and moved to a first position to cause one gear change from the presently selected gear position, and while the gear shift structure is in the first position, the gear shift structure being constructed and arranged to be manually engaged again to cause a gear change from the one gear change position.

12. The system of claim 11, further comprising a controller associated with the transmission and gear shift structure, and at least one sensor, associated with the controller, for sensing a state of the vehicle, wherein the gear change, from the one gear change position, is based on a signal sent to the controller by the sensor to 1) to optimize vehicle fuel economy based on the state of the vehicle, or 2) to maximize engine braking.

13. The system of claim 12, wherein controller is constructed and arranged to ensure that the one gear change is one gear position up or one gear position down from the presently selected gear position and that the gear change, from the one gear change position, is a change to a maximum gear change position allowed by the controller.

14. The system of claim 12, wherein the gear shift structure is a gear shift lever constructed and arranged to place the transmission in a park, drive, reverse or neutral position.

15. The system of claim 14, wherein the gear shift lever is constructed and arranged to be bumped and moved in a certain direction to the first position to cause the one gear change from the presently selected gear position, and then bumped and moved again in the certain direction to a second position to cause the gear change from the one gear change position.

16. The system of claim 15, wherein the gear shift lever is constructed and arranged such that bumping force required to bump the gear shift lever to the second bump position thereof is greater than a bumping force required to bump the gear shift lever to the first bump position thereof.

17. The system of claim 12, wherein the gear shift lever includes a switch such that once the one gear change is achieved, activation of the switch causes the gear change from the one gear change position.

18. The system of claim 11, wherein the gear shift structure includes at least one paddle shifter.

19. The system of claim 12, wherein the gear shift structure includes a pair of paddle shifters with one paddle shifter being constructed and arranged to be engaged two consecutively times to optimize vehicle fuel economy based on the state of the vehicle, or the other of the paddle shifters being constructed and arranged to be engaged two consecutive times to maximize engine braking.

20. The system of claim 11, wherein the sensor is constructed and arranged to sense speed of the vehicle, a throttle position of the engine, or a presently selected gear position.
